(19) United States
(12) Patent Application Publication
(10) Pub. No.: US 2013/0126109 A1
(43) Pub. Date: May 23, 2013

(54) Silicate Free Refiner Bleaching

(71) Applicant: Buckman Laboratories International, Inc., Memphis, TN (US)

(72) Inventor: Shuyu Wang, Lakeland, TN (US)

(73) Assignee: BUCKMAN LABORATORIES INTERNATIONAL, INC., Memphis, TN (US)

(21) Appl. No.: 13/627,458

(22) Filed: Sep. 26, 2012

Related U.S. Application Data
(60) Provisional application No. 61/560,935, filed on Nov. 17, 2011.

(51) Int. Cl. D21C 9/10; C09K 3/00; D21C 3/26; D21C 1/02; D21C 3/02

(52) U.S. Cl. 162/25; 252/186.43

(57) ABSTRACT

A method for bleaching pulp includes introducing a bleaching liquor in at least one refiner to contact lignocellulosic particulates processed therein in the formation of pulp, wherein the bleaching liquor includes at least one peroxide, magnesium sulfate, caustic hydroxide, at least one chelating agent, and less than 0.1%, or less than 0.01%, or less than 0.001% by weight silicate based on dry weight of the lignocellulosic particulates. Magnesium perhydroxide is generated in situ in the refining system with bleaching of the particulates during refining and reduced scale occurs by use of the silicate or essentially silicate free conditions. A free or essentially silicate-free bleaching liquor which can provide highly brightened pulps also is described.

### BACKGROUND OF THE INVENTION

This application claims the benefit under 35 U.S.C. §119(e) of prior U.S. Provisional Patent Application No. 61/560,935, filed Nov. 17, 2011, which is incorporated in its entirety by reference herein.

The present invention relates to methods of silicate free or essentially silicate free refiner bleaching of pulps. Bleaching liquor which can be used in the methods is also provided.

Mechanical pulping is a process of mechanically processing wood into fibers for the purpose of making pulp. Mechanical pulping is attractive as a method for pulping because it can achieve higher yields as compared with chemical pulping since lignin can be retained to a large degree in mechanically pulped woods. Pulps made using any of the conventional mechanical pulping methods are mainly used for newsprint and printing papers. High yield mechanical pulps can be generally more difficult to bleach than chemical pulps because of the high lignin content.

There are many types of mechanical pulping, including stone grinding (SG), pressurized stone grinding (PSG), refiner mechanical pulping (RMP), thermomechanical pulping (TMP), and chemi-thermomechanical pulping (CTMP). RMP, TMP, and CTMP can further be grouped generally under refiner pulping processes. In RMP, wood chips are ground between rotating metal disks. The process usually is carried out in two stages. The first stage is mainly used to separate the fibers, while the second stage is used to treat the fiber surface for improved fiber bonding of paper products. In RMP, the wood chips are refined at atmospheric pressure in both a first and a second stage refiner. The refiner processes generate heat by the friction of the metal disks rubbing against the wood. The heat is liberated as steam, which is often used to soften the incoming chips. TMP differs from RMP in that the pulp is processed in a pressurized refiner. In the TMP process, two stages also are normally used. The first stage refiner operates at an elevated temperature and pressure, and the second stage refiner is typically at or near atmospheric pressure. Pulps made by a TMP process can have high strength. The pulp produced by the TMP process can tend to be darker than most other pulps. Alkaline bleaching of mechanical pulps produced by the TMP process has been carried out using caustic and oxidative reagents, such as hydrogen peroxide.

U.S. Pat. No. 4,270,976 to Sandstrom et al. relates to a TMP process used to produce peroxide bleached, mechanical pulp by introducing a peroxide containing bleaching solution into the grinding space of a refiner. In the process of Sandstrom, alkalinity is supplied by caustic (sodium hydroxide). Sodium silicate is used which acts as a pH buffer for the sodium hydroxide and for stabilizing the peroxide. The peroxide bleaching causes oxalate formation. In turn, the highly dissolved alkali concentration with sodium hydroxide and sodium silicate promotes the formation of oxalate scale deposits on the refiner plates, which can interfere with the operation and efficiency of the refiner. Refiner bleaching using sodium hydroxide and sodium silicate causes refiner plate filling, erratic refiner load, and “slick” pulp resulting in inadequate refining of the wood. The use of sodium silicate also requires separate facilities to store the chemical and pumps to meter the correct dosage. Darkening of the pulp can be attributed to the addition of excess quantities of sodium hydroxide. Oxalate scale can even be present in the finished paper products. The aforementioned problems illustrate that refiner bleaching with sodium hydroxide and sodium silicate has many drawbacks that make commercial use difficult and expensive.

U.S. Pat. No. 4,718,980 to Lowrie et al. relates to a two-stage pulp refining system in which the fibrous material from the first stage refiner is in contact with an alkaline bleaching solution between refining stages at a temperature of 32°-96° C. and at a consistency of 15-25% on an oven dry basis. The material is then diluted and then pressed to a consistency of at least 20% and passes through the second stage refiner. The alkaline bleaching solution is shown to contain hydrogen peroxide, sodium hydroxide, sodium silicate, and a chelating agent.

U.S. Patent Application Publication No. 2004/0112557 A1 to Parrish et al. relates to methods of bleaching mechanical pulp under alkaline conditions with hydrogen peroxide wherein the methods include introducing a source of magnesium ions and hydroxyl ions such as magnesium oxide or magnesium hydroxide, and optionally a source of perhydroxyl ions such as hydrogen peroxide, to a refiner, which are compared to conventionally used bleaching liquors which include sodium hydroxide and sodium silicate. A chelating agent can be added to the wood particulates prior to the refiner. Parrish et al. indicates that sodium hydroxide cannot be added at or before the refiner.

U.S. Patent Application Publication No. 2004/0069427 A1 to Xu et al. relates to multi-stage alkaline peroxide mechanical pulping with the addition of one or two alkaline peroxide treatment solutions before primary refining as a pretreatment and/or after primary refining with an intermediate line treatment solution as a refiner blow line treatment. This process is used for making chemimechanical pulp (APMP). At least one of the alkaline peroxide pretreatment solutions contains specified amounts of silicate, DTPA, MgSO₄, peroxide, and total alkalinity.

U.S. Patent Application Publication No. 2002/0189021 A1 to Haynes et al. relates to a method of making bleached mechanical pulps for pulping mills having a primary and a secondary refiner. A first step is to provide cellulosic materials, such as wood chips to refine into the pulp, which have an initial brightness level. A second step is to provide a bleaching liquor to the refining system of the pulp mill, wherein the liquor comprises an amount of hydrogen peroxide and an amount of alkali having greater than 0% to 100% magnesium hydroxide (Mg(OH)₂) or soda ash (Na₂CO₃) or a combination thereof. A third step is to hold the pulp with the bleaching liquor at a temperature in the range of about 85° to about 160° C. and for about 2 to about 180 minutes, and increasing the brightness of the pulp as compared to if 100% of the alkali is NaOH. The bleaching liquor can optionally further include a chelating agent, such as APCA, EDTA, DTPA, NTA, phosphonic acids, EDTMP, DTPMP, NTMP, polycarboxylic acids, gluconates, citrates, polyacrylates, polyasparates, or combinations thereof.

As indicated, many conventional peroxide bleaching liquors have contained silicates with peroxide and caustic, chelant, and/or magnesium sulfate. Silicates and chelant are two stabilizers which can deactivate transition metals, such as Mn, Fe, and Cu. In the past, silicates have been considered an essential component in peroxide bleaching. Silicates may act as a peroxide preserver during peroxide bleaching. When silicate is used in the conventional peroxide bleaching, the brightness can gain several points than without the silicate. However, as indicated, use of silicates in the bleach liquors in a refiner tends to create a scale problem, which limits the use of silicates in peroxide refiner bleaching. Prior bleaching liquors can have very low efficiency without silicate. Further, use of conventional peroxide bleaching liquors has required relatively lengthy minimum retention times, such as about 60 minutes or more. In order to apply a conventional bleaching liquor which contains silicate to a refiner, a pretreatment stage has been added since retention time is too short in a refiner itself to conduct normal peroxide bleaching. Conventional bleaching liquor which contains silicate has not been used in refiner bleaching. Further, magnesium sulfate has been used in conventional peroxide bleaching liquor as a stabilizer in combination with other stabilizers, and not as the sole stabilizer in peroxide bleaching.

Accordingly, the present invention has realized that there is a need to find alternative methods of refiner bleaching that cures many of the aforementioned problems with using silicates.

### SUMMARY OF THE PRESENT INVENTION

A feature of the present invention is to provide a method for refiner peroxide bleaching with bleaching liquor which can be free or essentially silicate free, and prevent or reduce scale formation in the refining system.

An additional feature of the present invention is to provide bleaching liquor which can give a high brightness gain for refiner peroxide bleaching.

Another feature of the present invention is to provide increased production rates by reducing or eliminating post-refining peroxide retention times needed for bleaching.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates, in part, to a method for bleaching pulp, comprising (a) introducing lignocellulosic particulates to a refining system for conversion to a pulp; (b) providing a bleaching liquor in the refiner to contact the lignocellulosic particulates, wherein the bleaching liquor comprising at least one peroxide, magnesium sulfate, caustic hydroxide, at least one chelating agent, and less than 0.1%, or less than 0.01%, or less than 0.001% by weight silicate based on dry weight of the lignocellulosic particulates, wherein magnesium perhydroxide is generated in situ in the refining system; and (c) refining the lignocellulosic particulates in the refining system to form pulp. The bleaching liquor can be essentially silicate free. For purposes herein, “essentially silicate free” means that “no silicate is deliberately added” to the bleaching liquor, and includes 0 wt % silicate or less than 0.1 wt % silicate. The bleaching liquor can be formed in situ in a refiner by separate introductions of different components of the liquor to the refiner or refiners, or the liquor can be added as a preformulated single composition to the refiner or refiners. The at least one chelating agent can be added to the lignocellulosic particulates prior to the refining system, such as by combining the chelating agent with the lignocellulosic particulates in a chip washer prior to the refining system to provide washed lignocellulosic particulates, steaming the washed lignocellulosic particulates in the presence of steam in a steamer to form steamed lignocellulosic particulates, and conducting the steamed lignocellulosic particulates to the refining system for treatment with the bleaching liquor. As an example, the source of the peroxide can be hydrogen peroxide, the caustic hydroxide can be sodium hydroxide, and/or the chelating agent can comprise dialkylene polyamine polymethylene phosphonic acid, dialkylene polyamine polymethylene phosphonic acid salt, dialkylene polyamine polycarboxylic acid, or dialkylene polyamine polycarboxylic acid salt, or any combinations thereof. The bleaching liquor can comprise from about 0.5% to about 5% by weight hydrogen peroxide, from about 0.1% to about 1.0% by weight magnesium sulfate, from about 1% to about 3% by weight caustic hydroxide, from about 1% to about 3% by weight chelating agent, and/or less than 0.1% by weight silicate, all based on dry weight of the lignocellulosic particulates. The refining system can comprise a multi-stage refining system comprising a primary refiner and a secondary refiner, wherein all of the bleaching liquor can be added at the primary refiner, or all at the primary refiner and secondary refiner. As an option, separate retention or holding of the bleaching liquor and the pulp after the primary refiner or the secondary refiner can be reduced or omitted while yielding bleached pulps having increases in brightness suitable for use in a paper machine. The pulp can have an ISO Brightness (% ISO) of from about 50 to about 75 after the refining and/or any holding of the pulp. The chelating agent can be added to the lignocellulosic particulates prior to the refining system effective to increase ISO Brightness (% ISO) of the pulp, as determined after the refining and the holding of the pulp, at least about 0.5 units higher than pulp made with addition of the chelating agent at the refining system. As an option, a refiner to which at least a portion or all of the bleaching liquor can be added can be or include a pressurized refiner or a refiner operated at atmospheric pressure. The pressurized refiner to which at least a portion or all of the bleaching liquor can be added can be a primary refiner or a secondary refiner.

The present invention further relates to a bleaching liquor composition for lignocellulosic materials comprising at least one peroxide, magnesium sulfate, caustic hydroxide, at least one chelating agent, and less than 0.1%, or 0.01%, or 0.001% by weight silicate based on total composition weight.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the features of the present invention and together with the description, serve to explain the principles of the present invention.

### BRIEF DESCRIPTION OF DRAWINGS

FIG. 1 is a process flow chart showing a method according to an example of the present application.

FIG. 2 is a process flow chart showing a method according to another example of the present application.

FIG. 3A is a process flow chart showing a method according to another example of the present application.

FIG. 3B is a process flow chart showing a method according to another example of the present application.

### DETAILED DESCRIPTION OF THE PRESENT INVENTION

The present invention relates to bleaching of pulps with silicate free or essentially silicate free caustic bleaching liquors. By using the bleaching liquors of the present invention, magnesium perhydroxide can be generated in situ in a refining system that is used for pulp production (e.g., mechanical pulp production) with bleaching of the particulates during refining and reduced scale occurring by use of the silicate or essentially silicate free conditions. As used herein, “silicate” refers to any source of silicate ions (SiₓO_{y}^{-z}), where x, y, and z are positive values which balance the charges on the moiety. For example, the excluded silicates in methods and bleaching liquors of the present invention can be SiO₃⁻² silicates, including any inorganic sources thereof (e.g., Na₂SiO₃, CaSiO₃, H₂Mg₃(SiO₃)₄, (NH₄)₂SiO₃) or any organic sources thereof (e.g., alkyl SiO₃⁻² silicates). Silicates, such as SiO₃⁻² silicates, can improve peroxide bleaching, but cause deposits or scale, such as in the refiner or headbox approach piping or elsewhere in the pulp mill, and can increase anionic debris, such as on the wet end of a paper machine using pulp treated with silicates. This can lead to issues with retention and drainage. The bleaching liquor can reduce or prevent scale formation in pulp refiners and/or other equipment in pulp mills and still give brightness gains. Increased production rates also can be obtained as post-refining retention times can be reduced or eliminated without sacrificing brightness when using a bleaching liquor of the present invention. The bleaching liquor of the present invention can be used to bleach lignocellulosic particles in the form of pre-refining lignocellulosic particles, partially refined pulps, reject pulps, or any combinations thereof.

The method of the present invention can treat lignocellulosic particles with a silicate-free or essentially silicate free bleaching liquor that includes peroxide(s), caustic hydroxide(s), magnesium sulfate(s), and chelating agent(s) to generate magnesium perhydroxide (e.g., MgO(OH)₂) in situ in a refiner to conduct peroxide bleaching. The exclusion of all or essentially all silicates from the bleaching liquor can reduce or eliminate scale formation otherwise induced by the presence of silicates in the refiner system. For instance, as shown by the results of experiments described in the examples herein, silicate-free bleaching liquors of the present invention can bleach wood fiber in a refiner to increase brightness with improved metal removal and chelation and without scale formation, and without the need of increasing retention times with retention or holding vessel after refiners. As indicated, to reduce or eliminate scale, magnesium perhydroxide can be generated in situ with use of the bleaching liquor of the present invention. It is believed that the magnesium perhydroxide generated in situ stabilizes peroxide, which can permit more efficient bleaching to be achieved in the refiner itself. As an option, all of the bleaching liquor can be added at a single refiner. As another option, if a multi-stage refiner arrangement is used, then all of the bleaching liquor can be added at a primary refiner thereof, or alternatively can be added (in any ratio) at the primary and secondary refiners (or more, if used). As an option, the refiner to which at least a portion or all of the bleaching liquor can be added can be or can include a pressurized refiner. The refiner to which at least a portion or all of the bleaching liquor can be added can be a refiner operated at atmospheric pressure. As an option, at least a portion of the chelating agent can be added ahead of (before) the refiner, such as at a chip washer that precedes the primary refiner. The addition of chelating agent to the lignocellulosic material in advance of the primary refiner can assist in increasing the refiner bleach stock brightness which is achieved. As an option, the chelating agent can comprise combinations of dialkylene polyamine polymethylene phosphonic acid and one or more dialkylene polyamine polymethylene phosphonic acid salts.

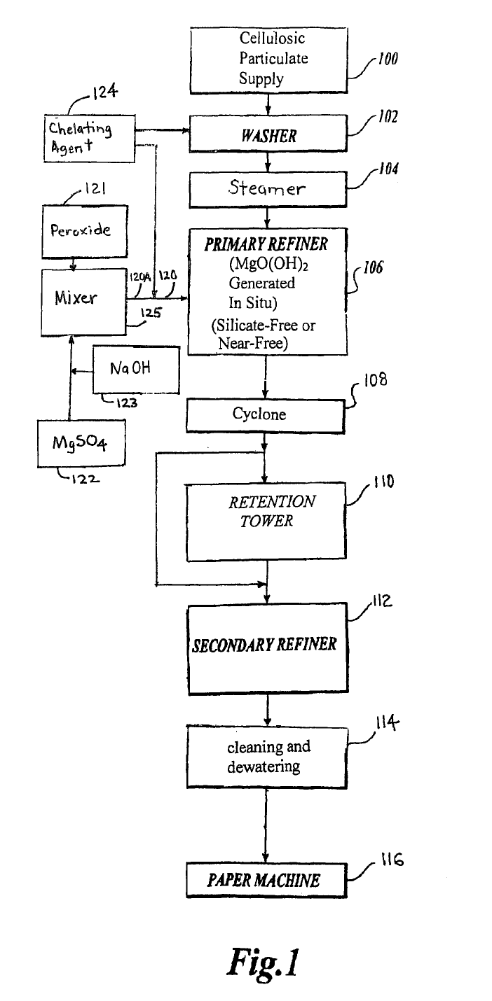

Referring now to FIG. 1, a representative method according to the present invention is schematically illustrated. A two-stage refining system with associated unit operations, including an optional retention tower after the primary refiner, is represented.

Block 100 represents a suitable supply of cellulosic particulates, such as wood chips coming from chip storage silos. Wood chips suitable for use in the present invention can be derived from softwood tree species such as, but not limited to: fir (such as Douglas fir and balsam fir), pine (such as Eastern white pine and Loblolly pine), spruce (such as white spruce), larch (such as Eastern larch), cedar, and hemlock (such as Eastern and Western hemlock). Examples of hardwood tree species include, but are not limited to: acacia, alder (such as red alder and European black alder), aspen (such as quaking aspen), beech, birch, oak (such as white oak), gum trees (such as eucalyptus and sweet gum), poplar (such as balsam poplar, Eastern cottonwood, black cottonwood, and yellow poplar), maple (such as sugar maple, red maple, silver maple, and big leaf maple). These types of woods can be used individually or in any combinations thereof. For instance, a combination of hemlock and cottonwood particulates can be used.

The wood chips which can come from storage silos are washed in a washing apparatus represented by block 102. Washing can remove grit or debris present in the chips that may damage the refiner and cause premature wear of the plates. The chip washer can receive hot water from steam producers and steam users within the paper mill, and may operate at a temperature, for example, of about 35° C. to about 100° C. After the chip washer, a steamer or “preheater,” represented by block 104, can be provided. The steamer can be, for example, a steam vessel. Steamers can expose the wood chips to steam to soften the lignin in the wood. Operating conditions in the steamer can be dependent on the wood chip species, and size. On hemlock wood chips of typical size, for example, the steamer can operate at a pressure of about 25-35 psig and a retention time period of about 2 to about 5 minutes. Steamers are common in mechanical refining mills. As an option, the steamer can use steam recovered from a downstream cyclone separator and/or steam from a make-up line to heat the wood chips prior to feeding the chips into a primary refiner. Softening the lignin in the chips can conserve energy in the refining stages. The consistency of softened wood chips exiting the steamer and prior to refining can be adjusted by addition of water. For example, a conventional plug wiper and pump arrangement can be used for this purpose (not shown). As used herein, “consistency” as used herein refers to the ratio of solids to liquids expressed as a percentage.

A primary refiner, designated as block 106, is provided after the steamer. A refiner is an apparatus that mechanically separates the cellulosic particulates into their constituent fibers resulting in liberation of the single fiber cellulosic pulp. There are two principal types of refiners which are generally known in the pulp industry, which are disc refiners (e.g., double disc refiners) and conical refiners. As an option, either is suitable to be used in the present invention. As an option, the primary refiner can be a pressurized refiner that can operate in the range of from slightly above atmospheric pressure to several tens of pounds per square inch of pressure. Typical operating pressure can be about 10 psig to about 40 psig, but may be higher or lower. Secondary and/or any other additional refiners can operate at near atmospheric or above atmospheric pressures. The primary refiner can operate at a pressure of about 25 to about 40 psig. One or more refiners are common in mechanical pulp refining mills. Refining can add a substantial amount of heat to the wood chips from the friction generated by the rotating plates. The heat is liberated in the form of steam in a downstream separator, such as a cyclone, which is shown in block 108. As an option, the pulp can be formed as a mechanical pulp.

As indicated, the bleaching liquor can be silicate free or essentially silicate free. As an option, the bleaching liquor that is introduced to the refiner for conversion of the cellulosic particles to pulp can comprise at least one peroxide, magnesium sulfate, caustic hydroxide, at least one chelating agent, and less than 0.1%, or less than 0.01%, or less than 0.001% by weight silicate based on dry weight of the lignocellulosic particulates. These silicate amounts are based on the total amount silicate from all sources. The exclusion of all or essentially all silicates from the bleaching liquor can reduce or eliminate scale formation otherwise induced by the presence of silicates in the refiner system. As another advantage of the bleaching liquor of the present invention, magnesium perhydroxide can be generated in situ in the refining system with use of the indicated bleaching liquor composition of the present invention. Magnesium perhydroxide can be represented by the chemical formula (MgO(OH)₂). In aqueous solution of sufficiently high pH (e.g., about 5 to about 9), higher pH can give a higher concentration of perhydroxyl ions (HOO⁻), which is more favorable for formation of magnesium perhydroxide. References to magnesium perhydroxide herein can encompass these ionic species thereof. The magnesium perhydroxide provides bleaching action with respect to the cellulosic particles in the presence of the caustic hydroxide, chelating agent, and sulfate ions. The bleaching liquor can be formed in situ in a refiner by separate introductions of different components of the liquor to the refiner or refiners, or the liquor can be added as a preformulated single composition to one refiner or a plurality of refiners in a multi-staged refining system. As shown in FIG. 1, the peroxide 121, magnesium sulfate 122, and caustic hydroxide 123 can be precombined in a mixer 125, and the resulting combination 120A can have chelating agent 124 added to form a bleaching liquor 120 which can be fed to the primary refiner 106. As an option, the primary refiner 106 to which the bleaching liquor can be directly fed at least in part or completely can be or include a pressurized refiner operated at elevated temperature (e.g., 125° F. to 300° F. or higher, or 200° F. to 280° F. or 250° F. to 300° F.). The mixer 125 can be, for example, a vessel including an agitator suitable for mixing the components to form a substantially uniform mixture thereof. Suitable pumping, valving, mixing, and other equipment (not shown) can be adapted for used in the handling of these components in this manner. The bleaching liquor 120 can be silicate-free or essentially silicate-free when introduced into the primary refiner 106. The primary refiner can be operated, for example, without any source of silicate introduced therein.

Peroxide, shown in block 121, can be hydrogen peroxide or a peroxide source. Hydrogen peroxide can be introduced in aqueous solution forms. As an option, hydrogen peroxide may be used in industrial grades thereof, for example, in solutions containing about 10 wt % to about 60 wt % hydrogen peroxide, or other concentrations. As an option, the peroxide may be a peroxide source which can generate hydrogen peroxide when introduced into or when dissolved or otherwise present in an aqueous medium. The peroxide source can be, for example, percarbonates like sodium percarbonate, perborates like sodium perborate, alkaline peroxides like sodium, magnesium or calcium peroxide, hydrogen peroxide adducts of urea such as urea hydrogen peroxide (carbamide peroxide), and hydrogen peroxide adducts of pyrophosphates and phosphates like sodium phosphate perhydrate, or any combination thereof.

Magnesium sulfate (MgSO₄), shown in block 122, can be added to the bleaching liquor in dry powder or crystalline particulate form. As an option, anhydrous magnesium sulfate (i.e., without water of crystallization) may be used, or magnesium sulfate may be sourced from a magnesium sulfate hydrate, such as magnesium sulfate monohydrate or magnesium sulfate heptahydrate (e.g., MgSO₄.7H₂O). As shown in FIG. 1, the magnesium can be precombined with the caustic hydroxide for introduction together to a mixer where the bleaching liquor is prepared.

Caustic hydroxide, shown in block 123, can be a strong alkali hydroxide. The alkali hydroxide can be, for example, sodium hydroxide, potassium hydroxide, or other strong alkali hydroxide, individually or in any combinations thereof. The caustic hydroxide can be used in amounts effective to increase the pH of bleaching liquor sufficient to assist in the production of active bleaching species in the mixture, such as perhydroxyl ions.

Chelating agent, shown in block 124, can be added directly to the primary refiner as part of bleaching liquor 120 as an option. As another option, also shown in FIG. 1, the chelating agent can be added to the lignocellulosic particulates prior to the refining system, such as by combining the chelating agent with the lignocellulosic particulates in a chip washer 102 prior to the refining system to provide washed lignocellulosic particulates, steaming the washed lignocellulosic particulates in the presence of steam in a steamer to form steamed lignocellulosic particulates, and conducting the steamed lignocellulosic particulates to the refining system for treatment with the bleaching liquor. The chelating agents can be useful to bind or control metals (e.g., manganese, iron, copper) which otherwise can cause decomposition of hydrogen peroxide. Suitable chelating agents include, but are not limited to, amino polycarboxylic acids (APCA), ethylenediaminetetraacetic acid (EDTA), diethylenetriaminepentaacetic acid (DTPA), nitrilotriacetic acid (NTA), phosphonic acids, ethylenediaminetetramethylene-phosphonic acid (EDTMP), diethylenetriaminepentamethylenephosphonic acid (DTPMP), nitrilotrimethylenephosphonic acid (NTMP), polycarboxylic acids, gluconates, citrates, polyacrylates, and polyaspartates, or any combination thereof. As an option, the chelating agent can comprise dialkylene polyamine (e.g., polymethylene phosphonic acid diethylenetriaminepentamethylenephosphonic acid (DTPMP)), dialkylene polyamine polymethylene phosphonic acid salt, dialkylene polyamine polycarboxylic acid (e.g., diethylenetriaminepentaacetic acid (DTPA)), dialkylene polyamine polycarboxylic acid salt, or any combinations thereof. DTPMP can be used in partially neutralized form as salts, such as sodium salts thereof. For example, DTPMP-Na7 replaces seven of the ten hydroxyl groups (—OH) of the acid form with —ONa groups, and can be referred to as partially neutralized, whereas DTPMP-Na10 replaces all of the hydroxyl groups (—OH) of the acid form with —ONa groups, and can be referred to as fully neutralized. Blends of chelating agents, in acid, partially neutralized, and fully neutralized forms may be used. The chelating agents can be pH sensitive. The use of active chelating agents at different levels of neutralization can permit the chelating agent to better match the pH of the system, such as by being more tolerant of lower and higher pH's and able to sequester metals in aqueous solution under those conditions. In addition to chelating agents, the pulp can also be provided with bleaching aids.

The bleaching liquor can comprise from about 0.5% to about 5% by weight hydrogen peroxide, from about 0.03% to about 1.0% by weight magnesium sulfate, from about 1% to about 3% by weight caustic hydroxide, from about 0.05% to about 3% by weight chelating agent, and/or less than 0.1% by weight silicate, all based on dry weight of the lignocellulosic particulates. The bleaching liquor can comprise from about 0.6% to about 4% by weight hydrogen peroxide, from about 0.08% to about 1.0% by weight magnesium sulfate, from about 1% to about 2.75% by weight caustic hydroxide, from about 0.1% to about 2.75% by weight chelating agent, and/or less than 0.01% by weight silicate, all based on dry weight of the lignocellulosic particulates. The bleaching liquor can comprise from about 0.75% to about 3% by weight hydrogen peroxide, from about 0.1% to about 0.9% by weight magnesium sulfate, from about 1% to about 2.5% by weight caustic hydroxide, from about 0.15% to about 2.5% by weight chelating agent, and/or less than 0.001% by weight silicate, all based on dry weight of the lignocellulosic particulates. The component amounts given for the bleaching liquors are based on pure compound amounts, excluding any aqueous carrier or additives which may be used therewith or as a carrier for the component. As an option, the bleaching liquor typically can contain at least some aqueous content, and may optionally contain additional additives such as bleaching aids, pH modifiers, or other additives in amounts effective for their respective functions.

As an option, if the bleaching liquor composition is preformulated and used as a single added composition to the refiner, the composition can have from about 1% to about 40% by weight hydrogen peroxide, from about 1% to about 15% by weight magnesium sulfate, from about 35% to about 1% by weight caustic hydroxide, from about 35% to about 1% by weight chelating agent, and/or less than 0.1% by weight silicate, all based on total bleaching liquor composition weight. The bleaching liquor composition can have from about 3% to about 30% by weight hydrogen peroxide, from about 1.5% to about 12.5% by weight magnesium sulfate, from about 25% to about 1% by weight caustic hydroxide, from about 25% to about 1% by weight chelating agent, and/or less than 0.01% by weight silicate, all based on total bleaching liquor composition weight. As another option, the bleaching liquor composition can have from about 5% to about 25% by weight hydrogen peroxide, from about 2% to about 10% by weight magnesium sulfate, from about 20% to about 2% by weight caustic hydroxide, from about 20% to about 2% by weight chelating agent, and less than 0.001% by weight silicate, all based on total bleaching liquor composition weight. The component amounts given again are based on pure compound amounts thereof. As an option, and as indicated, the bleaching liquor typically can contain at least some aqueous content, and may optionally contain additional additives such as those indicated.

The refining system can comprise at least one refiner at which the bleaching liquor of the present invention can be introduced and contacted with the lignocellulosic particulates in the refiner. As an option, a multi-stage refining system comprising a primary refiner 106 and an additional secondary refiner 112 can be used, wherein the bleaching liquor is introduced entirely at the primary refiner, or entirely at the secondary refiner, or introduced in part at both (in any ratio). In the illustration shown in FIG. 1, all of the bleaching liquor can be added at the primary refiner. In the primary refiner, the alkalinity of the bleaching liquor can cause swelling of the fibers that facilitates their separation thus, reducing load. The refined wood chips leaving the primary refiner can be referred to as pulp. As an option, the pulp from the primary refiner can have a high consistency ranging from about 20% to about 50%. However, as other options, the methods according to the present invention can be practiced in medium and low consistency processes. Medium consistency is typically about 10% to about 20% and low consistency is less than 10% and as low as about 3%. As an option, for a TMP process using metal disks rubbing against the wood under a pressurized condition, a typical load on the refiner when using the bleaching liquor of the present invention can be, for example, about 300 to about 3,000 kilowatt-hours per ton of pulp. The pH of the pulp exiting the primary refiner can be, for example, from about 5 to about 10, or from 5 to about 9, or other values within these ranges. As indicated, a primary refiner to which the bleaching liquor can be directly fed can be or include a pressurized refiner. The pressurized refiner can be pressurized to operate in the range of from slightly above atmospheric pressure to about 60 pounds per square inch of pressure based on gauge pressure (psig)), such as, for example, from about 1 psig to about 60 psig, or from about 5 psig to about 55 psig, or from about 10 psig to about 50 psig, or from about 15 psig to about 47 psig, or from about 25 psig to about 40 psig, or from about 27 psig to about 37 psig, or other pressures. The operating temperature of the pressurized refiner to which the bleaching liquor can be fed can be from about 75° F. to about 300° F. or higher, such as from about 75° F. to about 280° F., or from about 100° F. to about 270° F., or from about 125° F. to about 250° F., or other temperatures.

The pressure on the pulp can be reduced after exiting the primary refiner, which results in separation of the heat and water from the pulp via steam production. The separation operation, generally represented by block 108, can operate as one or a series of pressurized and/or atmospheric pressure vessels. As an option, the separator is a cyclone separator operated at normal atmospheric pressure or at a pressure slightly higher than atmospheric pressure. The steam can be collected from the separator and optionally can be used in steam users, such as the steamer, for energy conservation purposes (not shown). In addition, steam condensate from the steamer can be used in the chip washer (not shown). For example, the steam generated by the drop in pressure from the primary refiner to the separator can be used in the steamer, block 104. Condensed steam or condensate from the steamer can be routed to the chip washer, block 102.

As an option, the pulp exiting the primary refiner and cyclone may enter a dewatering operation (not shown), such as a mechanical press (e.g., a screw press) or other suitable apparatus to dewater and increase the consistency of the pulp at this stage before the pulp enters the secondary refiner, represented by block 116.

The need for separate retention or holding of the bleaching liquor and the pulp after the primary refiner 106 (or the secondary refiner 112) can be reduced or omitted while yielding bleached pulps having brightness ready for use in a papermaking machine. As another option, before reaching any secondary refiner, the pulp optionally can be conveyed from the cyclone to a peroxide retention tower, represented by block 110. If used, the pulp continues to undergo the bleaching reaction in the peroxide retention tower 110 for the retention or holding period used. As an option, an additional retention period can be provided in retention tower 110 at a temperature of from about 40° C. to about 100° C., or from about 50° C. to about 100° C., for a holding time period of from about 0 minutes to about 60 minutes, or from about 0 to about 8 minutes, or from about 1 to about 60 minutes, or from about 1 to about 8 minutes. It is possible to include a bleaching tower after the secondary refiner 112, or if there are more than two refiners, the bleaching tower can be provided after the last refiner. In these alternate options, the indicated bleaching liquor can be added at the primary refiner and any one or more of the secondary refiners (not shown). It has been found that the bleaching liquor of the present invention can make it possible to eliminate or reduce the need to provide additional holding of pulp and bleaching liquor in a retention tower for bleaching after the primary refiner or refiners to achieve satisfactory bleaching and brightness in final pulps.

As shown in FIG. 1, the pulp exiting cyclone 108 after the primary refiner 106 can be fed directly to a secondary refiner 112. As an option, the secondary refiner, if used, can be a single disc refiner. As an option, the secondary refiner can be operated at atmospheric pressure. Alternatively, the secondary refiner can be operated at a pressure greater than atmospheric pressure. The secondary refiner, if pressurized, can be pressurized to operate in the range of from slightly above atmospheric pressure to about 60 pounds per square inch of pressure based on gauge pressure, such as, for example, from about 1 psig to about 60 psig, or from about 5 psig to about 55 psig, or from about 10 psig to about 50 psig, or from about 15 psig to about 47 psig, or from about 25 psig to about 40 psig, or from about 27 psig to about 37 psig, or other pressures. As an option, the load on the secondary refiner can be in the range indicated for the primary refiner. As an option, the consistency of the pulp leaving the secondary refiner can be about 15% to about 50%. As an option, the wood chips and total bleaching liquor can be processed through the refining system at a rate ratio (dry fiber tons/hr: total bleaching liquor tons/hr) of from about 1:0.010 to about 1:0.1, or from about 1:0.005 to about 1:0.1.

The pulp exiting the secondary refiner 112 can receive post-refining processing, generally indicated in block 114, which can include, for example, dilution, cleaning, and dewatering operations. Conventional devices and methods of use for these post-refining operations can be adapted for use in the present invention. The pulp leaving the secondary refiner, for example, can enter a dilution chest (not shown), wherein the consistency of the pulp can be reduced to about 1% to about 6%, before the pulp is cleaned up. From the dilution chest, the pulp can be screened in one or a plurality of screening devices to remove any oversized fibers which can then be routed for further refining into any one of the refiners (not shown), such as the secondary refiner. The screening operation can reduce the consistency of the pulp, for example, to as low as about 1%. After the screening process, the pulp can enter a water separation apparatus (not shown), which can be used to further separate water from the screened pulp to provide a desired consistency. As an option, the pulp consistency leaving the water separation apparatus can be from about 2% to about 35%, or from about 3% to about 12%. The pulp product leaving these operations of further processing can be ready for use in a papermaking machine 116. The pulp product also may be stored in any storage vessel for a period of time (not shown), before being sent to the paper machine.

The final pulp produced according to the invention can have brightness achieved by using the bleaching liquor of the present invention which can be comparable or better to using caustic silicate-based compositions without the drawbacks of silicates, namely, without scale formation issues. As an option, the final pulp of methods of the present invention can have ISO Brightness (% ISO) of from about 50 to about 75, or from about 55 to about 72, or from about 58 to about 70, or other values, after the refining and any holding of the pulp. As an option, the chelating agent can be added to the lignocellulosic particulates prior to the refining system effective to increase ISO Brightness (% ISO) of the pulp, as determined after the refining and the holding of the pulp, at least about 0.5 units higher, or at least about 0.6 units higher, or at least about 0.7 units higher, or at least about 0.8 units higher, or at least about 0.9 units higher, or at least about 1 or more units higher than pulp made with addition of the chelating agent at the refining system. As an option, the final pulp can have a Canadian Standard Freeness value of about 50 to about 250, or other values.

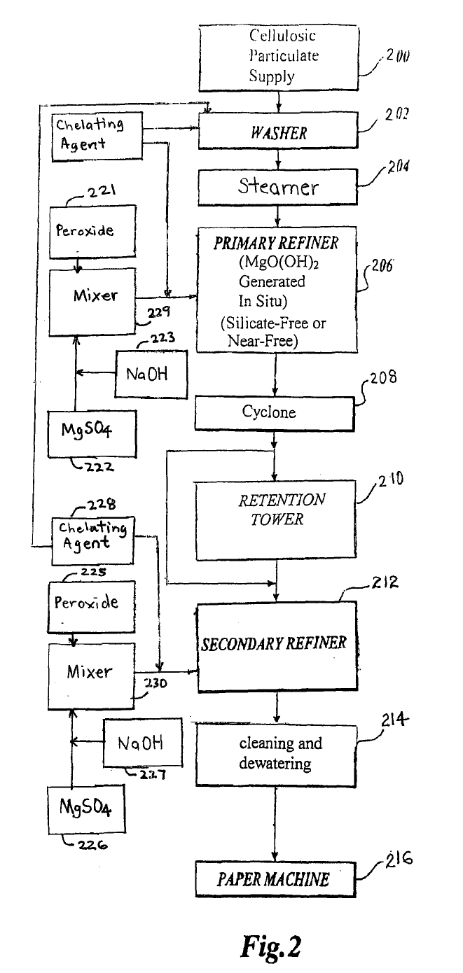

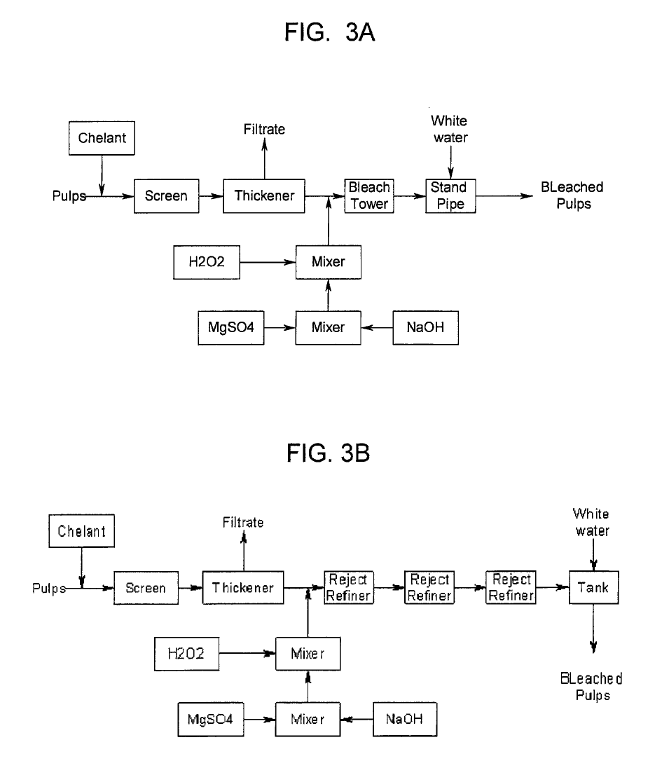

As an option, and as shown in indicated FIG. 2, the bleaching liquor can be added at both the primary refiner and a secondary refiner. As an option, the bleaching liquor components can be added at the second refiner in similar concentrations as indicated for addition at the primary refiner with respect to the process shown in FIG. 1. Blocks 200, 202, 204, 206, 208, 210, 212, 214, 216, 221, 222, 223, 224, and 229 shown in FIG. 2 can correspond to blocks 100, 102, 104, 106, 108, 110, 112, 114, 116, 121, 122, 123, 124, and 125, respectively, as described for FIG. 1 and reference is made thereto. The peroxide block 225, magnesium sulfate block 226, caustic hydroxide 227, chelating agent 228, and mixer 230 in FIG. 2 can correspond to blocks 221-224, 229 and 121-125, respectively, other than the difference in the particular refiner being fed with these bleaching liquor components. The bleaching liquor can be added at other locations in a pulp mill, such as shown in FIGS. 3A and 3B. For example, the bleaching liquor can be added at a reject refiner for second stage peroxide bleaching. TMP reject refiner pulp can have longer and coarser fibers than mainline refiner pulp. A reject refiner can be used in a pulp mill, for example, for secondary refining of coarser pulp fibers as a fraction which has been separated, such as by screening, from primary fibers downstream of an earlier refiner. The bleaching liquor can be added before and/or at a reject refiner to bleach the reject refiner pulps.

The present invention includes the following aspects/embodiments/features in any order and/or in any combination:
1. The present invention relates to a method of bleaching pulp, comprising:

(a) introducing lignocellulosic particulates to a refining system for conversion to a pulp;

(b) providing a bleaching liquor in the refiner to contact the lignocellulosic particulates, wherein the bleaching liquor comprising at least one peroxide, magnesium sulfate, caustic hydroxide, at least one chelating agent, and less than 0.1% by weight silicate based on dry weight of said lignocellulosic particulates, wherein magnesium perhydroxide being generated in situ in the refining system; and

(c) refining the lignocellulosic particulates in said refining system to form pulp.
2. The method of any preceding or following embodiment/feature/aspect, wherein said at least one chelating agent is added to the lignocellulosic particulates prior to the refining system.
3. The method of any preceding or following embodiment/feature/aspect, comprising combining the chelating agent with the lignocellulosic particulates in a chip washer prior to the refining system to provide washed lignocellulosic particulates, steaming the washed lignocellulosic particulates in the presence of steam in a steamer to form steamed lignocellulosic particulates, and conducting the steamed lignocellulosic particulates to the refining system for treatment with the bleaching liquor.
4. The method of any preceding or following embodiment/feature/aspect, wherein the chelating agent comprises dialkylene polyamine polymethylene phosphonic acid, dialkylene polyamine polymethylene phosphonic acid salt, dialkylene polyamine polycarboxylic acid, dialkylene polyamine polycarboxylic acid salt, or any combinations thereof.
5. The method of any preceding or following embodiment/feature/aspect, wherein the chelating agent comprises a combination of acidic dialkylene polyamine polymethylene phosphonic acid and at least one dialkylene polyamine polymethylene phosphonic acid which is at least partially neutralized.
6. The method of any preceding or following embodiment/feature/aspect, wherein the chelating agent comprises a combination of acidic diethylene triamine pentamethylene phosphonic acid (DTPMP) and at least one diethylene triamine pentamethylene phosphonic acid which is at least partially neutralized.
7. The method of any preceding or following embodiment/feature/aspect, wherein the chelating agent comprises diethylenetriaminepentaacetic acid (DTPA), diethylenetriaminepentaacetic acid salt, or any combinations thereof.
8. The method of any preceding or following embodiment/feature/aspect, wherein the source of said peroxide is hydrogen peroxide.
9. The method of any preceding or following embodiment/feature/aspect, wherein the caustic hydroxide is sodium hydroxide.
10. The method of any preceding or following embodiment/feature/aspect, wherein the bleaching liquor comprising from about 0.5% to about 5% by weight hydrogen peroxide, from about 0.03% to about 1.0% by weight magnesium sulfate, from about 1% to about 3% by weight caustic hydroxide, from about 0.05% to about 3% by weight chelating agent, and less than 0.1% by weight silicate, all based on dry weight of said lignocellulosic particulates.
11. The method of any preceding or following embodiment/feature/aspect, wherein the bleaching liquor comprising from 0 to 0.01% by weight silicate.
12. The method of any preceding or following embodiment/feature/aspect, wherein the bleaching liquor comprising from 0 to 0.001% by weight silicate.
13. The method of any preceding or following embodiment/feature/aspect, wherein the refining system comprises a pressurized refiner, wherein at least a portion of the bleaching liquor is added at or to the pressurized refiner.
14. The method of any preceding or following embodiment/feature/aspect, wherein the refining system comprises a multi-stage refining system comprising a primary refiner and a secondary refiner.
15. The method of any preceding or following embodiment/feature/aspect, wherein the primary refiner operates at an elevated temperature and pressure, and the secondary refiner is operated at approximately atmospheric pressure.
16. The method of any preceding or following embodiment/feature/aspect, wherein all of the bleaching liquor is added at the primary refiner.
17. The method of any preceding or following embodiment/feature/aspect, wherein all of the bleaching liquor is added at the primary refiner and secondary refiner.
18. The method of any preceding or following embodiment/feature/aspect, further comprising holding the bleaching liquor and the pulp after the primary refiner or the secondary refiner at a temperature of from about 40° C. to about 100° C. for a time period of from about 0 minutes to about 60 minutes.
19. The method of any preceding or following embodiment/feature/aspect, further comprising holding the bleaching liquor and the pulp after the primary refiner or the secondary refiner at a temperature of from about 50° C. to about 100° C. for a time period of from about 0 minutes to about 8 minutes.
20. The method of any preceding or following embodiment/feature/aspect, wherein the pulp has ISO Brightness (% ISO) of from about 50 to about 75 after the refining and any holding of the pulp.
21. The method of any preceding or following embodiment/feature/aspect, comprising adding the chelating agent to the lignocellulosic particulates prior to the refining system effective to increase ISO Brightness (% ISO) of the pulp, as determined after the refining and the holding of the pulp, at least about 0.5 units higher than pulp made with addition of the chelating agent at the refining system.
22. The method of any preceding or following embodiment/feature/aspect, wherein said pulp is a mechanical pulp.
23. A bleaching liquor composition for lignocellulosic materials comprising at least one peroxide, magnesium sulfate, caustic hydroxide, at least one chelating agent, and less than 0.1% by weight silicate based on total composition weight.
24. The bleaching liquor composition of any preceding or following embodiment/feature/aspect, comprising from about 1% to about 40% by weight hydrogen peroxide, from about 1% to about 15% by weight magnesium sulfate, from about 35% to about 1% by weight caustic hydroxide, from about 35% to about 1% by weight chelating agent, and less than 0.1% by weight silicate, all based on total bleaching liquor composition weight.

The present invention can include any combination of these various features or embodiments above and/or below as set forth in sentences and/or paragraphs. Any combination of disclosed features herein is considered part of the present invention and no limitation is intended with respect to combinable features.

The present invention will be further clarified by the following examples, which are intended to be only exemplary of the present invention. Unless indicated otherwise, all amounts, percentages, ratios and the like used herein are by weight.

### EXAMPLES

### Example 1

A reject refiner was used to conduct a single second stage peroxide bleaching. The refiner equipment used for TMP production included a commercial two (2) stage steel double disk design. The process flow of the bleaching process performed using a reject refiner was as shown in FIG. 3B. The pulp fiber feedstock was hemlock and cottonwood fiber (50/50 w/w). A silicate-free bleaching liquor was used that contained peroxide, caustic, chelant, and magnesium sulfate. The composition of the bleaching liquor contained 2% H₂O₂, 1.5% NaOH, 0.12% MgSO₄ (100%), and 0.2% chelating agent, with all amounts given by weight, based on dry weight of the fibers treated in the process. As shown in FIG. 3B, the components of the bleaching liquor were premixed before introduction to the refiner in a manner similar to that such as shown in FIG. 1 and described herein. The fibers and bleaching liquor composition were separately fed into the refiner and combined therein. The refiner temperature was 131° C. and the refiner pressure was 25 psig. The pulps were processed through the refiner at a substantially constant rate of about 9.15 tons/hr based on dry weight thereof, and the indicated bleaching liquor composition was added at a substantially constant rate of about 0.125 tons/hr based on the dry fiber weight. The total bleaching retention time in the refiner was less than five minutes. The bleached pulp exiting the refiner was sampled before any further chemical processing or retention time. The % ISO brightness of the pulp samples were measured before and after the indicated refining process. The brightness (ISO) of the pulps was determined on handsheets prepared from the pulps. The handsheets were prepared according to TAPPI T 218 (“Forming Handsheets for Reflectance Tests of Pulp”) or a substantially equivalent method. The TMP pulp was bleached from 46% ISO to 67% ISO. After 72 total hours of operation of the refiner using the indicated bleaching liquor, no significant scale formation was visibly detected.

### Example 2

The reject refiner as used in Example 1 again was used to conduct a second stage peroxide bleaching. The pulp fiber again was hemlock and cottonwood fiber (50/50 w/w). In this example, the composition of the bleaching liquor was 1.25% H₂O₂, 2% NaOH, 0.12% MgSO₄, and 0.2% chelating agent, with all amounts given by weight based on dry weight of the fibers treated in the process. The fibers and bleaching liquor composition were separately fed into the refiner and combined therein. The refiner temperature was 60-85° C. and the refiner pressure was 0 psig. Total bleaching retention time in the refiner was less than five minutes. The TMP pulp was bleached from 46% ISO to 72% ISO. In another similar run using 1.25% H₂O₂ in the bleaching liquor, all other materials and conditions substantially the same, the TMP pulp was bleached from 46% ISO to 73.3% ISO.

### Example 3

The reject refiner and conditions as used in Example 1 again was used to conduct a second stage peroxide bleaching. The pulp fiber again was hemlock and cottonwood fiber (50/50 w/w). In this example, the composition of the bleaching liquor was similar to that indicated for Example 1 with a difference that 0.1% MgSO₄ was used initially. The brightness of the bleached TMP pulp initially was determined to be 66.9% ISO. Magnesium sulfate addition was temporarily discontinued while the process continued to run for a time period of about 3.5 hours. The brightness of the bleached TMP dropped from 66.9 to 64.1% ISO in the time period when the magnesium sulfate addition was stopped. When the magnesium sulfate addition was renewed, the brightness of the TMP pulp recovered to 67% ISO.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of bleaching pulp, comprising:
(a) introducing lignocellulosic particulates to a refining system for conversion to a pulp;
(b) providing a bleaching liquor in the refiner to contact the lignocellulosic particulates, wherein the bleaching liquor comprising at least one peroxide, magnesium sulfate, caustic hydroxide, at least one chelating agent, and less than 0.1% by weight silicate based on dry weight of said lignocellulosic particulates, wherein magnesium perhydroxide being generated in situ in the refining system; and
(c) refining the lignocellulosic particulates in said refining system to form pulp.

2. The method of claim 1, wherein said at least one chelating agent is added to the lignocellulosic particulates prior to the refining system.

3. The method of claim 1, comprising combining the chelating agent with the lignocellulosic particulates in a chip washer prior to the refining system to provide washed lignocellulosic particulates, steaming the washed lignocellulosic particulates in the presence of steam in a steamer to form steamed lignocellulosic particulates, and conducting the steamed lignocellulosic particulates to the refining system for treatment with the bleaching liquor.

4. The method of claim 1, wherein the chelating agent comprises dialkylene polyamine polymethylene phosphonic acid, dialkylene polyamine polymethylene phosphonic acid salt, dialkylene polyamine polycarboxylic acid, dialkylene polyamine polycarboxylic acid salt, or any combinations thereof.

5. The method of claim 1, wherein the chelating agent comprises a combination of acidic dialkylene polyamine polymethylene phosphonic acid and at least one dialkylene polyamine polymethylene phosphonic acid which is at least partially neutralized.

6. The method of claim 1, wherein the chelating agent comprises a combination of acidic diethylene triamine pentamethylene phosphonic acid (DTPMP) and at least one diethylene triamine pentamethylene phosphonic acid which is at least partially neutralized.

7. The method of claim 1, wherein the chelating agent comprises diethylenetriaminepentaacetic acid (DTPA), diethylenetriaminepentaacetic acid salt, or any combinations thereof.

8. The method of claim 1, wherein the source of said peroxide is hydrogen peroxide.

9. The method of claim 1, wherein the caustic hydroxide is sodium hydroxide.

10. The method of claim 1, wherein the bleaching liquor comprising from about 0.5% to about 5% by weight hydrogen peroxide, from about 0.03% to about 1.0% by weight magnesium sulfate, from about 1% to about 3% by weight caustic hydroxide, from about 0.05% to about 3% by weight chelating agent, and less than 0.1% by weight silicate, all based on dry weight of said lignocellulosic particulates.

11. The method of claim 1, wherein the bleaching liquor comprising from 0 to 0.01% by weight silicate.

12. The method of claim 1, wherein the bleaching liquor comprising from 0 to 0.001% by weight silicate.

13. The method of claim 1, wherein the refining system comprises a pressurized refiner, wherein at least a portion of the bleaching liquor is added at the pressurized refiner.

14. The method of claim 1, wherein the refining system comprises a multi-stage refining system comprising a primary refiner and a secondary refiner.

15. The method of claim 14, wherein the primary refiner operates at an elevated temperature and pressure, and the secondary refiner is operated at approximately atmospheric pressure.

16. The method of claim 14, wherein all of the bleaching liquor is added at the primary refiner.

17. The method of claim 14, wherein all of the bleaching liquor is added at the primary refiner and secondary refiner.

18. The method of claim 14, further comprising holding the bleaching liquor and the pulp after the primary refiner or the secondary refiner at a temperature of from about 40° C. to about 100° C. for a time period of from about 0 minutes to about 60 minutes.

19. The method of claim 14, further comprising holding the bleaching liquor and the pulp after the primary refiner or the secondary refiner at a temperature of from about 50° C. to about 100° C. for a time period of from about 0 minutes to about 8 minutes.

20. The method of claim 18, wherein the pulp has ISO Brightness (% ISO) of from about 50 to about 75 after the refining and any holding of the pulp.

21. The method of claim 18, comprising adding the chelating agent to the lignocellulosic particulates prior to the refining system effective to increase ISO Brightness (% ISO) of the pulp, as determined after the refining and the holding of the pulp, at least about 0.5 units higher than pulp made with addition of the chelating agent at the refining system.

22. The method of claim 1, wherein said pulp is a mechanical pulp.

23. A bleaching liquor composition for lignocellulosic materials comprising at least one peroxide, magnesium sulfate, caustic hydroxide, at least one chelating agent, and less than 0.1% by weight silicate based on total composition weight.

24. The bleaching liquor composition of claim 23, comprising from about 1% to about 40% by weight hydrogen peroxide, from about 1% to about 15% by weight magnesium sulfate, from about 35% to about 1% by weight caustic hydroxide, from about 35% to about 1% by weight chelating agent, and less than 0.1% by weight silicate, all based on total bleaching liquor composition weight.
